(19) United States
(12) Patent Application Publication
(10) Pub. No.: US 2026/0268802 A1
(43) Pub. Date: Sep. 10, 2026

(54) PEDIATRIC CLINICAL TRAINING SYSTEMS AND RELATED METHODS

(71) Applicant: The Children's Medical Center Corporation, Boston, MA (US)

(72) Inventors: Caleb P. Nelson, Waban, MA (US); Eric M. Bortnick, Boston, MA (US); Andrea K. Balthazar, Boston, MA (US); Michael G. Silver, Ashland, MA (US)

(73) Assignee: The Children's Medical Center Corporation, Boston, MA (US)

(21) Appl. No.: 19/163,367

(22) PCT Filed: Mar. 7, 2024
(86) PCT No.: PCT/US2024/018794

§ 371 Date: Sep. 8, 2025

Related U.S. Application Data
(60) Provisional application No. 63/489,682, filed on Mar. 10, 2023.

(51) Int. Cl. G09B 23/32

(52) U.S. Cl. CPC G09B 23/32

(57) ABSTRACT

Training kit systems for infant examination are generally described. A training kit system may help train healthcare trainees on proper pelvic examination to determine the state of the infant's testes. In some embodiments, the training kit system may train a healthcare trainee to identify cryptorchidism conditions in an infant. The training kit system may include one or more partial infant torso manikins which may exhibit different testis conditions, such a normal scrotal testis, a palpable inguinal undescended testis, nonpalpable undescended testis, and palpable retractile testis. The trainee may be tasked with performing physical examinations on the manikins to help distinguish the various conditions. In some embodiments, the manikins may include testis simulators which may be palpable through the skin of the manikin, and may further be mobile relative to a portion of the manikin to mimic the testes' natural movement.

### FIELD

Disclosed embodiments are related to clinical training systems and related methods. More specifically, systems and methods for training of physical examination of infants are disclosed.

### BACKGROUND

Cryptorchidism is a medical condition referring to an undescended testicle or testis which has not properly entered the scrotum during a male's infancy. The condition occurs in around 3-4% of newborns, with risks of occurrence increasing up to 20-30% for premature babies. If the testis does not naturally descend within the first few months of infancy, external intervention in the form of a surgical procedure is typically needed to ensure proper descension.

Without treatment, cryptorchidism can increase the risks of testicular cancer in adulthood, testicular torsion, and inguinal hernias. In addition, undescended testes stored in the lower abdominal area can be warmer than those stored in the scrotum, resulting in incomplete maturation of sperm within the testes, which can yield infertility issues later in adulthood.

Given the availability of effective treatment options, healthcare professionals are commonly tasked with diagnosing cryptorchidism in infancy. Thus, the Inventors have appreciated the desirability to train healthcare professionals to diagnose cryptorchidism in infants.

### SUMMARY

In some embodiments, a training manikin includes a body corresponding to a partial human torso, the body including at least one skin layer, at least one support layer, and at least one canal configured to house a testis simulator, the at least one canal disposed between the least one skin layer and the at least one support layer in a region of the body corresponding to at least a portion of an inguinal canal.

In some embodiments, a training manikin includes a body corresponding to a partial human torso, the body configured to model a nonpalpable undescended testis condition, the body including at least one canal disposed in a region of the body corresponding to at least a portion of an inguinal canal.

In some embodiments, a training manikin includes a body corresponding to a partial human torso, the body including at least one testis simulator, wherein the testis simulator is moveable relative to the body.

In some embodiments, a training kit includes at least one training manikin configured to model two or more of the following testis conditions: (a) palpable inguinal undescended testis condition, (b) palpable retractile testis condition, and/or (c) normal scrotal testis.

In some embodiments, a training manikin includes a body corresponding to a partial human torso, the body configured to model a palpable inguinal undescended testis condition.

In some embodiments, a training manikin includes a body corresponding to a partial human torso, the body configured to model a palpable retractile testis condition.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1A-1B show an isometric view and a top down view of a manikin, respectively, according to some embodiments;

FIG. 2 shows a cross-sectional view of the manikin of FIG. 1B taken along the line 2-2;

FIG. 3 shows a cross-sectional view of the manikin of FIG. 1A taken along the line 3-3;

FIG. 4 shows an exploded view of a manikin according to some embodiments;

FIG. 5 shows a bottom up view of a partial manikin according to some embodiments;

FIG. 6 shows a top down view of a partial manikin according to some embodiments;

FIG. 7 shows a top down view of a partial manikin according to other embodiments;

FIGS. 8A-8B shows top down views of a partial manikin according to other embodiments still;

FIG. 9 shows a top down view of a partial manikin according to other embodiments still;

FIG. 10 is an isometric view of a portion of the manikin;

FIG. 11 shows a training kit according to some embodiments;

FIG. 12 shows a training kit according to another embodiments; and

FIG. 13 shows a cross-sectional view of another embodiment of the manikin.

### DETAILED DESCRIPTION

Cryptorchidism is typically diagnosed using a physical examination of the male infant. A healthcare professional can palpate the scrotal and abdominal areas to help assess the state of the testes. The Inventors have recognized that given the size of male infants, physical examination of various testis conditions can be challenging. In particular, cryptorchidism conditions can be confused with retractile testes, wherein the cremaster muscle contracts and pulls the testes out of the scrotum due to an external stimulus. In both cases, the testis may not be in the scrotum during examination.

Furthermore, in some instances, the undescended testis may be positioned between the retroperitoneal abdomen and the inguinal ring, in the inguinal canal, or, possibly, in the abdomen. The testis may also be nonexistent or atrophic (e.g., abnormally small). An improperly trained healthcare professional may not be able to distinguish the complexities of the position, size, and presence of the testes during examination and subsequently misdiagnose the infant.

In view of the above, the Inventors have recognized the need for a training system to help healthcare trainees conduct physical exams to improve cryptorchidism diagnosis in male infants. The accuracy of physical examination during infancy can be critical, given the multitude of problems which may arise in adulthood if the condition is untreated. Proper and timely treatment, such as surgical intervention (e.g., orchiopexy), following diagnosis during infancy can greatly reduce said problems in adulthood.

In some embodiments, a training system may include one or more partial human infant torso manikins extending from the mid-torso to the upper thighs. The manikins may also include a scrotum cavity for palpation purposes. The manikins may demonstrate one or more testis conditions, including a normal scrotal testis, a palpable inguinal undescended testis, nonpalpable undescended testis, and palpable retractile testis. The system may help teach healthcare trainees proper testes examination training of infants to improve diagnosis of various testes conditions (e.g., cryptorchidism) in a hands-on fashion that mimics the real examination on an infant.

A trainee may be instructed to perform a mock examination on the manikins to better understand the steps involved in physical palpation of the inguinal and pelvic areas and both hemiscrota of the manikin. In some embodiments, the manikins may mimic the physical properties (e.g., elasticity) of a male infant for optimal realism, such that the training process may more accurately mimic a real infant examination. In this way, the trainee may readily transfer skills learned during the mock examination of the manikin to a real examination for more accurate diagnosis.

In some embodiments, the manikins may have an opaque outer skin, akin to natural infant tissue. Accordingly, the trainee may not be able to determine the testis condition of the manikin through visual inspection. Instead, the trainee must palpate the manikin in a standardized fashion to identify the state of the manikin's testes.

The manikins of the present disclosure may further include testis simulators palpable through an outer skin of the manikin, akin to human infant testes. For example, the simulators may be stiffer than the skin of the manikin, such that they may be palpably distinguishable. The testis simulator may be arranged in a fluid (e.g., a gel) to allow mobility within a portion of the manikin, which may again mimic natural testes movement. For example, a manikin exhibiting a normal testis condition may include a testis simulator arranged in a pocket or pouch of gel within the scrotum of the manikin. In this way, the testis simulator may be palpable and mobile within the manikin scrotum. The mobility of the simulator may therefore enhance the realism of the manikin examination and improve the training of the trainees.

Although cryptorchidism is commonly identified on the right testicle, in some embodiments, the manikins may mimic or model the same condition on both sides of the manikin (to mimic bilateral cryptorchidism), or may exhibit a first condition (e.g., normal scrotal testis) on a first side and a second condition (e.g., nonpalpable undescended testis) on the other side.

As will be described in greater detail below, a manikin exhibiting the palpable undescended testis condition may include a testis simulator which may be palpable within a region associated with the inguinal canal, but may not be moveable into the scrotum of the manikin. A manikin exhibiting the nonpalpable undescended testis condition may not include testis simulator (on the ipsilateral side of the examination) or may include a very small testis simulator to help the trainee improve their testis palpation skills. A manikin exhibiting the retractile testis condition may include a testis simulator which may be palpable within a region associated with the inguinal canal, and may also be moveable into the scrotum of the manikin. This condition will help a trainee distinguish a truly undescended testis and a retractile testis.

A healthcare trainee as described herein may refer to any clinical and/or healthcare professional who may need to examine an infant for cryptorchidism conditions. Trainees may include urology resident physicians, pediatric resident physicians, medical students, urologists, pediatricians, nurses, healthcare professionals, and/or any other suitable professional.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

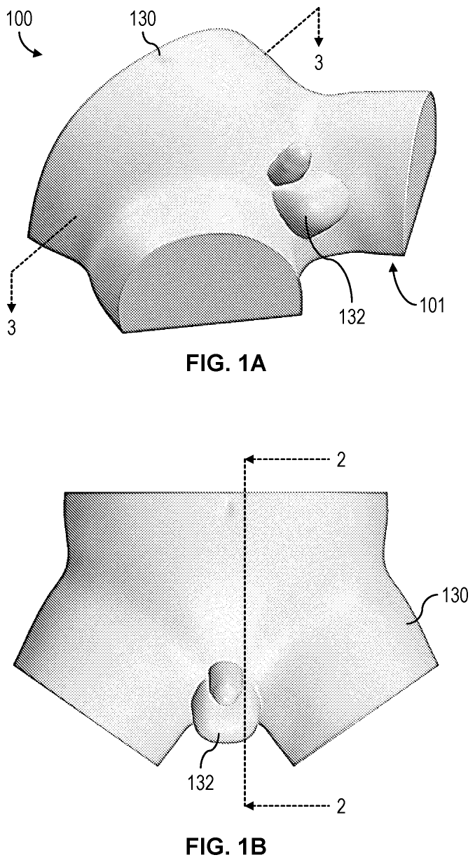

FIGS. 1A-1B show a training manikin 100 according to some embodiments. The manikin 100 may have the shape of a partial human infant torso including the pelvic region and a scrotum. The manikin may mimic a torso ranging between the umbilicus and the mid-thigh, as shown in FIGS. 1A-1B, although other torso portions are also contemplated. In some embodiments, the manikin may have the size and shape akin to an infant torso. The manikin may have a relatively flat bottom surface 101, such that the anterior portion of the torso may be facing up to the trainee, mimicking the orientation of a potential subject (e.g., infant patient) during examination. The flat bottom surface 101 may also help maintain the manikin 100 relatively stationary during examination Of course, embodiments having a non-flat bottom surface which more accurately represent the posterior portion of the torso are also contemplated to better mimic the dynamic nature of a real examination on a subject.

As shown in FIGS. 1A-1B, the tactile surface of the manikin 100 may include a skin layer 130. The skin layer 130 may include features that mimic the natural anterior torso anatomy for more realistic examination. The anatomical features may help guide and orient the trainee during the examination. Embodiments without anatomical features are also contemplated.

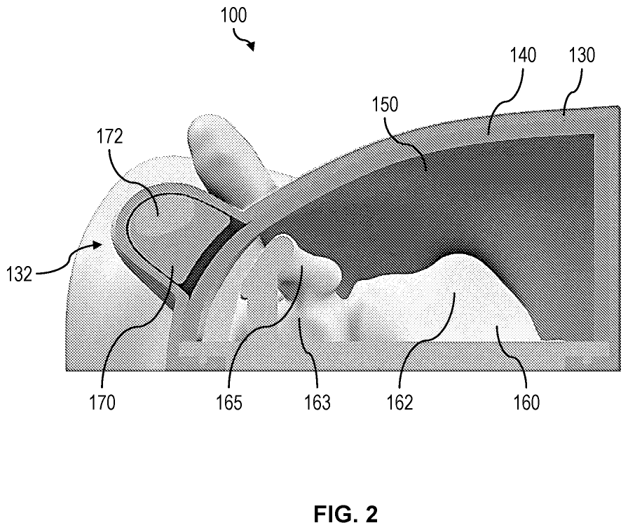

FIG. 2 shows a cross-sectional view of the manikin 100 of FIG. 1B taken along line 2-2. The cross-sectional view shows the interior of the manikin formed of various layers.

The manikin may include the outer skin layer 130, as previously described, which may include various anatomical features, as well as an inner skin layer 140, a support layer 150 (shown to be transparent in FIG. 2 for ease of visualization, and a landmark layer 160.

The outer layer 130 may have a scrotum feature 132, which may be a cavity formed between the outer layer 130 and the inner skin layer 140. The cavity may include a flexible pouch 170 filled with a fluid and a simulator 172 sized and shaped to mimic a testis. The testis simulator 172 may be housed in the pouch, which may be referred to as a volume. The fluid may allow the simulator to move within the pouch akin to the natural mobility of a testis in the scrotum. The testis simulator may be formed of a material with a stiffness greater than the pouch 170 and the outer skin layer 130, such that it may be palpable through said layers. It should be appreciated that the pouch 170 may be a thin flexible material arranged to hold fluid within the manikin scrotum.

In some embodiments, a manikin may include two skin layers to accurately mimic natural tissue and subcutaneous fat stiffness. To accurately mimic natural tissue, the outer skin layer 130 may be a thin layer of elastic material arranged around the inner skin layer 140, which may be thicker than layer 130, and may be more elastic. The inner skin layer may be formed of an elastomeric material to mimic the elasticity of natural soft tissue. However, elastomeric materials often exhibit high surface adhesion, such that they may be tacky. The tackiness does not properly mimic natural skin friction, such that it may comprise the test examination, for example if the trainee's hands cannot properly slide along the skin. Furthermore, the repeated use of the manikins for examination training would likely attract dirt and dust on the manikin and may require consistent cleaning and upkeep. Thus, the manikins of the present disclosure may include an outer layer which may be less tacky. The outer layer may have a thickness less than the inner layer to ensure that the overall elasticity of the manikin matches natural tissue stiffness.

The inner and outer skin layers may be formed of any suitable elastic material, including, but not limited to, thermoplastic elastomers, silicone rubbers, synthetic rubbers, polyolefins, polyurethanes, polytetrafluoroethylene, combinations thereof, and/or other elastic materials. In some embodiments, one or more of the skin layers may include a reinforced layer or a composite layer. For example, one or more of the skin layers may be formed of an embedded elastic nylon mesh material.

In some embodiments, the inner skin layer may have an approximate durometer between Shore 00-5 and 00-10, although approximate durometers between Shore 00-0 and 00-80 are also contemplated. In some embodiments, the outer skin layer may have an approximate durometer between 00-20 and 00-30, although approximate durometers between 00-0 and 00-80 are also contemplated.

In some embodiments, the inner skin layer may be approximately 4 mm thick, although thicknesses greater than or equal to 0.5 mm, 1 mm, 2 mm, 5 mm, 10 mm, 15 mm, 20 mm, 25 mm, 30 mm, and/or less than or equal to 30 mm, 25 mm, 20 mm, 15 mm, 10 mm, 5 mm, 2 mm, 1 mm, 0.5 mm, combinations thereof, and/or any other suitable inner skin thicknesses are also contemplated. In some embodiments, the outer skin layer may be approximately 3 mm thick although thicknesses greater than or equal to 0.5 mm, 1 mm, 2 mm, 5 mm, 10 mm, 12 mm, 15 mm, and/or less than or equal to 15 mm, 12 mm, 10 mm, 5 mm, 2 mm, 1 mm, 0.5 mm, combinations thereof, and/or any other suitable outer skin thicknesses are also contemplated. In some embodiments, the thicknesses of the outer and inner skin layers may be comparable, if the differences in elasticity ensure an overall manikin with an elasticity similar to natural tissue. In other embodiments, the thicknesses of the outer and inner skin layers may not be comparable. It should be appreciated that any suitable combination of thicknesses may be employed along with the elasticities of each layer to ensure a manikin which properly mimics the skin and fat layers of a subject.

It should be appreciated that the thicknesses and/or elasticities of the various skin layers may not be uniform across the manikin. Given the complex landscape of the torso and its variable structure, the thicknesses of the skin layers may be adjusted to fit the various other layers and result in a smooth, natural-looking torso. Accordingly, in some embodiments, the thicknesses listed above may be associated with the skin portion around the pelvic and inguinal regions.

It should also be appreciated that although two skin layers are shown and described relative to FIG. 2, arrangements formed of more than two skin layers are also contemplated to mimic natural tissue. In some embodiments, the two or more skin layers and the support layer may be replaced by a single layer. In other embodiments, the two or more skin layers, the support layer, and the landmark layer may all be formed of a single layer.

The testis simulator 172 may be formed of any suitable material that may be palpable through at least the outer skin layer. Additionally, the testis simulator material may be selected to limit the risk of absorbance or undesirable reaction with the fluid in the pouch 170. In some embodiments, the testis simulator may be formed of any suitable material. For example, the testis simulator may be formed of silicones (e.g., platinum cured silicones), urethanes, combinations thereof, and/or any other suitable elastic material. The testis simulator may have an approximate durometer between Shore 00-20 and 00-30, although approximate durometers between Shore 00-10 and Shore A-100 are also contemplated.

The testis simulator may be sized to mimic an atrophic (small) or orthotropic (normally sized) infant testis. Accordingly, the testis simulator may be sized with an average diameter between approximately 0.4 cm and 3 cm, although other naturally-occurring sizes of infant testes are also contemplated. Any of the testis simulators described herein may have any suitable size to facilitate training of normal and abnormal testis conditions, as the present disclosure is not limited by the size of the testis simulators.

The landmark layer 160 may be formed of a material stiffer than the other layers of the manikin 100, such that it may be palpable through said layers. The landmark layer may have the same tactile feel as bone or hard tissue when palpated through the skin. Accordingly, the landmark layer 160 may include various boney landmarks, such as the iliac crest 162 (right iliac crest shown in the cross-sectional view of FIG. 2), the pubic arch 163 (right arch shown in FIG. 2), and the public tubercle 165. These landmarks may serve as palpation guides during the examination to guide the trainee to the appropriate anatomy.

In some embodiments, the landmark layer may be formed of a stiff polymeric material. The complex architecture of the anatomies may be replicated using additive manufacturing techniques such as selective laser sintering, selective laser melting, fused deposition modeling, melt extrusion deposition, fused pellet deposition, direct-write modalities, combinations thereof, and/any other suitable technique. Accordingly, the landmark layer may be formed of a material compatible with the fabrication technique, including, but not limited to, nylon, acrylonitrile butadiene styrene, polylactic acid, polyethylene terephthalate and related polymers, polycarbonate, polypropylene, polyvinyl chloride, combinations thereof, and/or any other suitable material. Other materials and fabrication techniques are also contemplated, including molding or sculpting. In some embodiments, the landmark layer may be formed of a metallic, composite, and/or ceramic material. It should be appreciated that any suitable material may be employed to form the landmark layer as the present disclosure is not so limited.

In some embodiments, a support layer 150 may be arranged between the skin layers 130, 140 and the landmark layer 160. The support layer may serve as a spacer, such that it may provide a low-density body to the manikin without adding significant weight or material.

The support layer may have mechanical properties akin to the viscera and organs of the torso. The support layer may be stiff enough to support the skin layers 130, 140 without significant warpage, especially during tactile examination, while also being soft enough to allow the landmark layer 160 to be palpable through the support layer. The support layer may be formed of any suitable material, such as an open-celled foam, closed-cell foam, neoprene, synthetic sponge, porous scaffold, combinations thereof, and/or any other lightweight materials are also contemplated.

It should be appreciated that any of the components of the manikins described herein (e.g., gel of the canal/volume, testis, skin layers, landmark layer, support layer) may be formed of a material or combination of materials which may be stable for a long period of time and through repeated palpation exams. The manikins may be handled and probed by trainees for years without significant damage to the manikin or leakage of the fluids within the manikin. Accordingly, the materials of the manikins may be selected to have stable (e.g., non-volatile) properties.

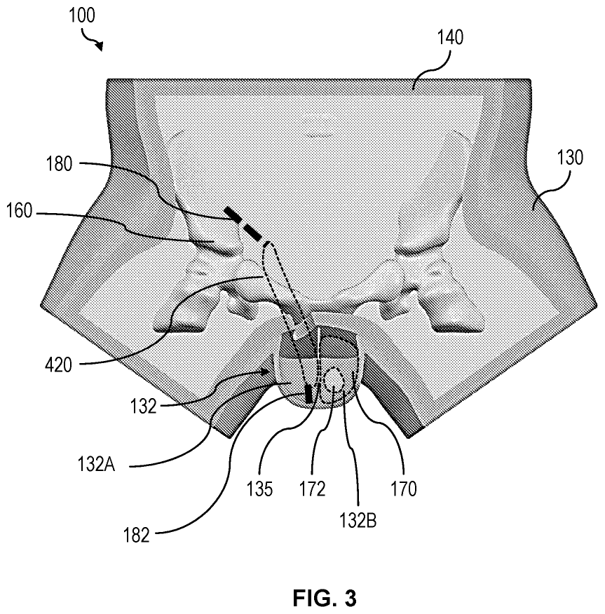

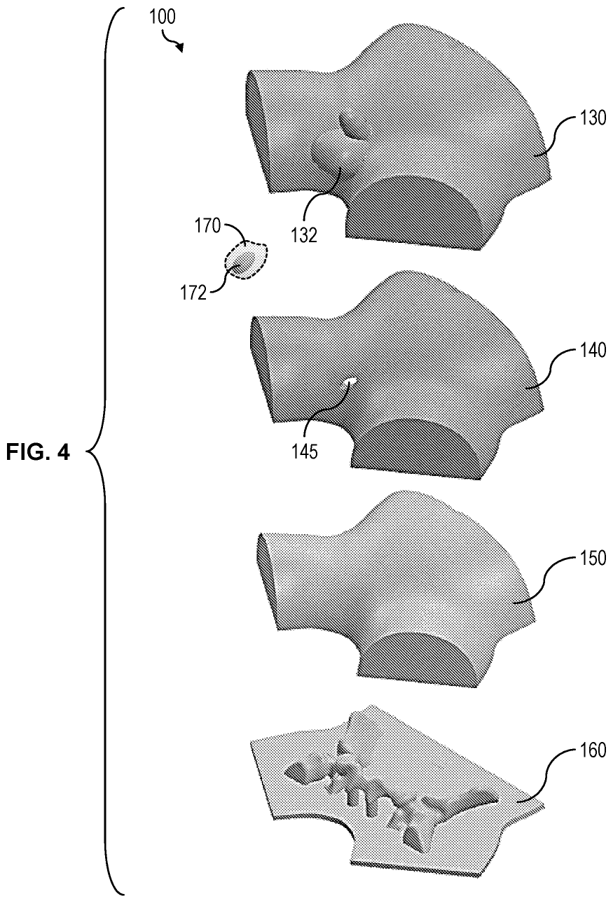

FIG. 3 shows a top-down view of a cross-section of the manikin of FIG. 1A taken along line 3-3. The support layer has been omitted in this view for visual clarity. As described previously, the manikin 100 may include an outer skin layer 130, an inner skin 140, a support layer (not shown), and a landmark layer 160, which may include boney landmarks of the torso region. As shown in FIG. 3, the outer skin layer 130 may include a scrotal pouch or cavity 132 which may include a right chamber 132A and a left chamber 132B separated by a septum 135 to mimic the natural scrotal septum. The chambers may each represent a hemiscrotum. The septum may be less than approximately 2-3 mm thick, to prevent the migration of fluid and/or testis simulators between the chambers.

In manikin 100 of FIG. 3, the left side of the patient exhibits a normal testis condition, as the testis simulator 172 is arranged in its pouch 170 in the manikin scrotum 132. The right side of the patient can be configured to mimic one or more testis conditions (e.g., cryptorchidism, retractile testis, non-existent testis condition). As will be described in greater detail below, the septum 135 may help palpably distinguish the various conditions for the trainee.

FIG. 4 shows an exploded view of a manikin 100 according to some embodiments. The manikin may include an outer skin layer 130 having one or more anatomical features, such as a manikin scrotal cavity 132. The outer skin layer may be arranged on top of an inner skin layer 140, which itself may be arranged on top of a support layer 150, all of which may be arranged on a landmark layer 160. As described previously, the number and arrangements may be adjusted to achieve a manikin which mimics the feel and elasticity of natural tissue. In some embodiments, the manikin may include at least one normal testis simulator 172 arranged in a pouch 170 in the manikin scrotal cavity 132 between the outer and inner skin layers.

It should be appreciated that the normal testis condition may be in either the left or the right halves of the manikin. In some embodiments, both left and right halves of the manikin may mimic a normal testis condition. In other embodiments, only one half of the manikin may mimic a normal testis condition. In other embodiments still, neither half of the manikin may mimic a normal testis condition. It should be appreciated that the testis simulator(s) of the present disclosure may be visually obscured by the skin layer(s), such that a trainee may not be able to distinguish the testis condition based on visual inspection alone. Accordingly, the manikin may exhibit any suitable combination of normal or abnormal conditions, as the present disclosure is not so limited.

As shown in FIG. 4, the inner skin layer may not include a scrotal cavity (although embodiments where the manikin scrotal cavity is positioned under both of the skin layers is also contemplated), but may instead include an opening 145, as will be described in greater detail below.

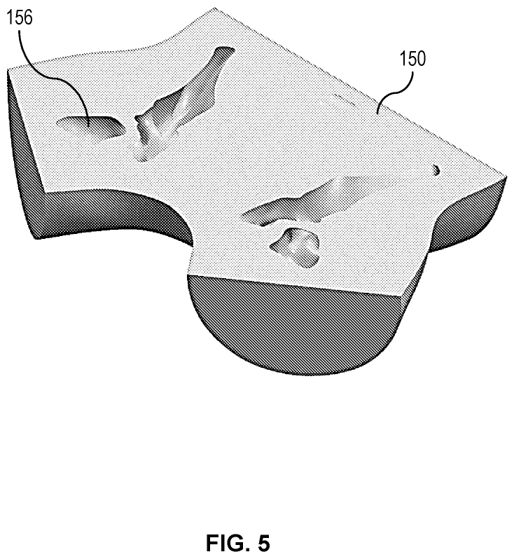

FIG. 5 shows a bottom up view of a support layer 150 according to some embodiments. As shown in FIG. 5, the support layer 150 may include one or more cavities 156 corresponding with the structurally complex landmark layer (see layer 160 in FIG. 4). In some embodiments, the support layer may be formed using a molding process.

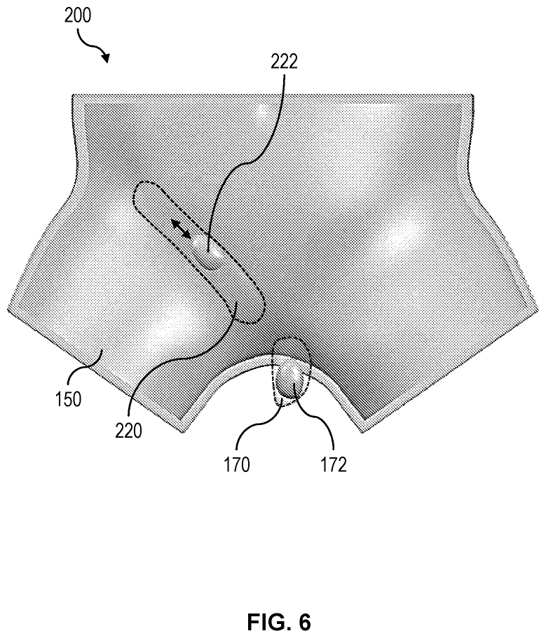

FIG. 6 shows a top down view of a manikin 200 according to some embodiments. For ease of visualization, the skin layers have been omitted from FIG. 6. Thus, the forward-facing feature is the support layer 150. The manikin 200 mimics a normal testis condition on its left side, with a testis simulator 172 arranged in a pouch 170, both of which may be seated in the left chamber of the manikin scrotal cavity of the outer skin layer (not shown). The right side mimics a palpable undescended testicle condition in which the testis is able to be felt in the inguinal canal but unable to be brought into the scrotum. Accordingly, the manikin 200 may include a second testis simulator 222 arranged in a canal or volume 220 corresponding to the inguinal canal. The volume 220 may be arranged along a portion of the abdomen corresponding to the inguinal canal, but may not extend into the scrotum (see manikin scrotal cavity 132 in FIGS. 1A-4).

The canal or volume 220 may be a pouch formed of a flexible material and filled with fluid to allow the testis simulator 222 to move within the volume 220, as indicated by arrows in FIG. 6. This behavior may mimic the movement of a natural testis within the inguinal canal. The fluid may be any suitable non-volatile fluid compatible with the materials employed, including, but not limited to, gels, grease, silicone grease, oil, mineral oil, lubricant, water, water-based solutions, solid-based lubricants, or combinations thereof, and/or any other suitable fluid or combinations of fluids or lubricants. In one embodiment, the lubricant is a 50/50 mix of Super Lube® (with Syncolon®, a polytetrafluoroethylene (PTFE) based lubricant) and mineral oil (i.e., 50% Super Lube® with Syncolon®, and 50% mineral oil). Super Lube® and Syncolon® are registered trademarks of the Synco Chemical Corporation, 24 Davinci Dr., Bohemia, NY 11716. Super Lube® (with Syncolon®) is available from the Synco Chemical Corporation. The fluid may be selected to limit the risk of leakage through the volume 220. It should be appreciated that the volume 220 may include a small volume of fluid (e.g., 2 mL) to enable testis simulator mobility without affecting the palpability of the manikin. In other words, the fluid itself may not be significantly palpable, in contrast with the testis simulator 222, which may be palpable through the various layers of the manikin. The testis simulator 222 may be formed of any of the materials described above relative to the normal testis.

In some embodiments, the canal or volume 220 may be a distinct pouch arranged between the support layer 150 and the skin layers. The pouch may be adhered to the support layer and/or skin layers to reduce the risk migration along the interface. In some embodiments, the volume 220 may be an indented channel formed in the support layer 150. In this way, the testis simulator 222 may be moveable along the channel, and the risk of the volume migrating may be minimized. It should be appreciated that the fluid in the volume (e.g., gel) may be selected with consideration of the material composition of the support and/or skin layers. Specifically, the fluid may not leach through the various layers of the manikin.

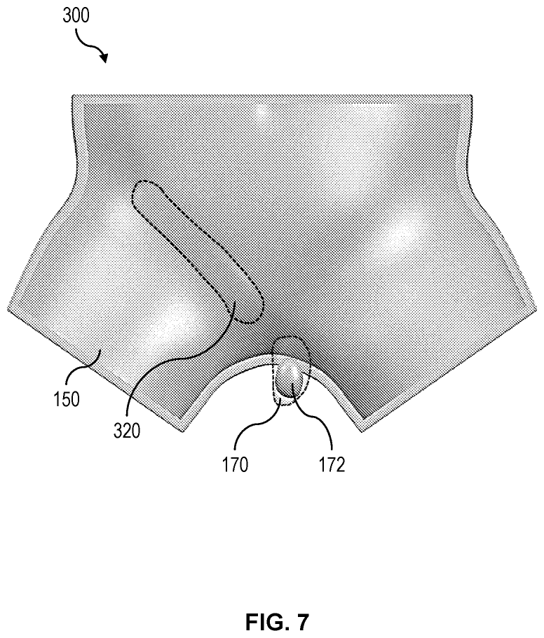

FIG. 7 shows a top down view of a manikin 300 according to some embodiments. For ease of visualization, the skin layers have been omitted from the figure. The manikin 300 mimics a normal testis condition on its left side, with a testis simulator 172 arranged in a pouch 170, both of which may be seated in the left chamber of the manikin scrotal cavity of the outer skin layer (not shown). On its right side, the manikin mimics a nonpalpable undescended testis condition. Accordingly, the manikin may include a canal or volume 320, which may have similar properties as volume 220 described relative to FIG. 6, but may not include a secondary testis simulator arranged in the volume.

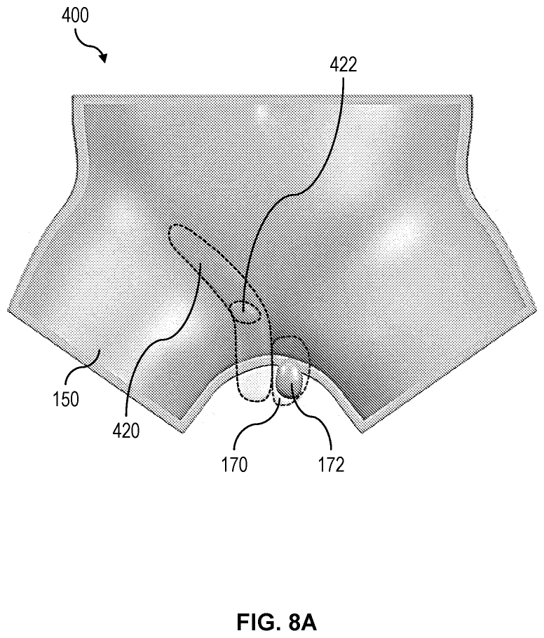

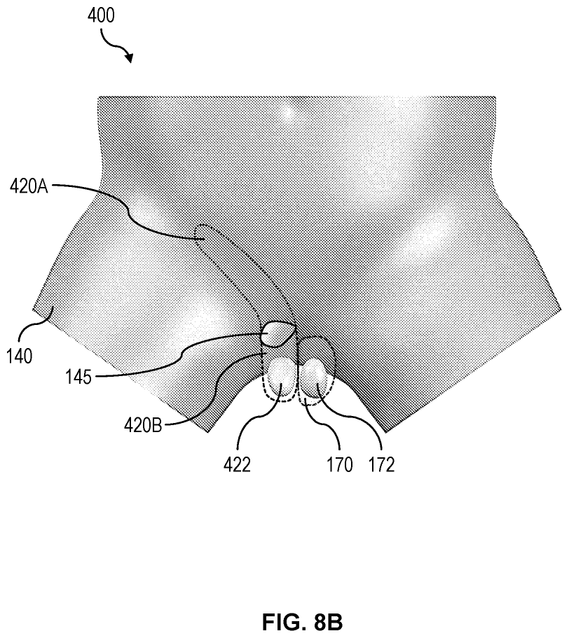

FIG. 8A shows a top down view of a manikin 400 according to some embodiments. For ease of visualization, the skin layers have been omitted from the figure. The manikin 400 mimics a normal testis condition on its left side, with a testis simulator 172 arranged in a pouch 170, both of which may be seated in the left chamber of the scrotal cavity of the outer skin layer (not shown). On its right side, the manikin mimics a palpable retractile testicle condition in which the testis is able to be felt in the inguinal canal and is able to be brought into the scrotum. Accordingly, the manikin 400 may include a second testis simulator 422 arranged in a canal or volume 420 corresponding to the inguinal canal. The volume 420 may be arranged along a portion of the abdomen corresponding to the inguinal canal, and may also extend into the manikin scrotum, in contrast to the volume 220 shown in FIG. 6. Accordingly, the testis simulator 422, which may be moveable along the volume 420 with the presence of a fluid (e.g., gel) may be manipulated and brought into the right chamber or hemiscrotum of the manikin scrotal cavity.

As described previously, the volume 420 may be a distinct pouch arranged between the skin layers and the support layer 150, or may be a channel formed in either the skin layers or the support layers. The volume 420 and testis simulator 422 may have similar properties to the volume and testis simulator described relative to FIG. 6.

FIG. 8B shows the manikin 400 of FIG. 8A with the addition of the inner skin layer 140. In some embodiments, the inner skin layer 140 may include an opening 145. In some embodiments, the volume 420 (as shown in FIG. 8A) may include a portion 420A (as shown in FIG. 8B) extending between the inner skin layer and the support layer, and a portion 420B passing through the opening 145 and arranged in the scrotal cavity (see manikin cavity 132 in FIGS. 1A-4). In this way, the testis simulator 422 may be moveable from the abdominal region into the manikin scrotum through the opening 145.

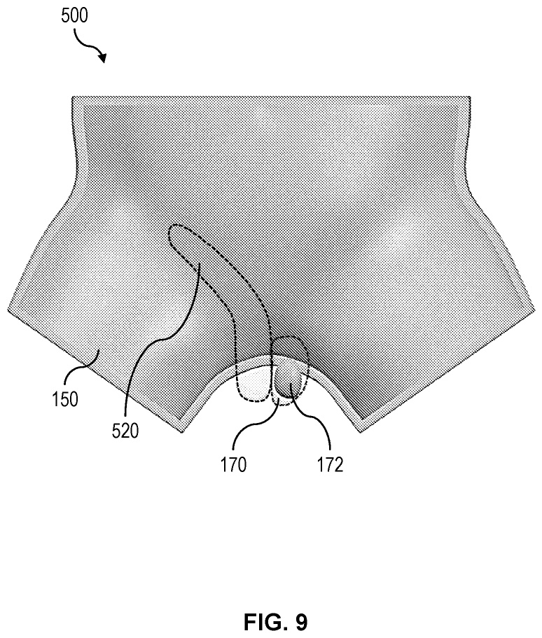

FIG. 9 shows a top down view of a manikin 500 according to some embodiments. For ease of visualization, the skin layers have been omitted from the figure. The manikin 500 mimics a normal testis condition on its left side, with a testis simulator 172 arranged in a pouch 170, both of which may be seated in the left chamber of the manikin scrotal cavity of the outer skin layer (not shown). On its right side, the manikin mimics another nonpalpable undescended testicle condition. Accordingly, the manikin may include a canal or volume 520, which may have similar properties as volume 220 described relative to FIG. 6, but may not include a secondary testis simulator arranged in the volume. The volume 520 may also extend through an opening of the inner skin layer (not shown) as described relative to manikin 400 of FIGS. 8A-8B.

The various pouches described herein (whether to mimic the canal or the used in the scrotum) may be formed of any suitable flexible material, including, but not limited to, silicones, urethanes, nitrile rubbers, synthetic rubbers, elastomers, elastic materials, a fabric reinforced material, combinations thereof, and/or any other suitable flexible materials. In one embodiment, the pouch may be formed of heat sealable poly bag such that after the fluid and the testis simulator (if the testis simulator is to be present) are placed in the pouch, one of both ends of the pouch may be heat sealed to retain the components therein. These arrangements may reduce the risk of leakage during palpation. In other embodiments, the fluid and the testis simulator may be directly positioned in the scrotum cavity or in the canal/channel of the outer skin layer, without a specific pouch. In other embodiments still, the fluid may be solid enough to limit the risk of leakage while still allowing the testis simulator to be mobile relative to the manikin. In some embodiments, the pouch may be replaceable, such that should the fluid not retain its properties, or the testis simulator becomes damaged or the pouch ruptures, a new fluid filled pouch with a testis simulator if desired may be substituted for the damaged arrangement.

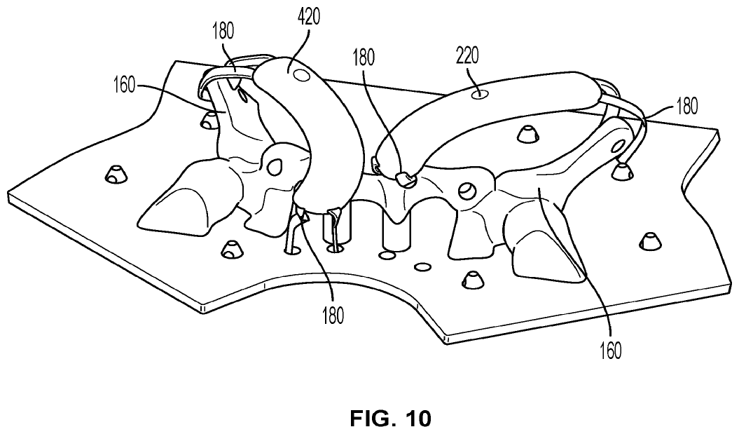

In any of the embodiments described herein, one or both pouch ends may be formed with or otherwise include a tether that aids in anchoring the end(s) of the pouch to attachment locations within the manikin. This may be desirable for the pouch that mimics the inguinal canal. For example, as shown in FIG. 3, one end of the pouch (whether pouch 220, 320, 420 or 520) may include a tether 180 that can be attached to the boney structure 160 and/or the other end of the pouch may include a tether 182 that can be attached to the inner/underside surface of a skin layer. Other attachment locations are contemplated as the present disclosure is not limited in this respect. As shown in FIG. 10, in one embodiment, the manikin includes two pouches (labeled 420 and 220) representing the right and left inguinal canals. As shown, the tethers 180 may be attached to the various structures in the manikin such as the boney structures 160. As noted above, the pouch may be replaceable such that the tethers can be disconnected from their associated attachment locations. In this respect, the tethers may be glued, clamped or stitched in place in a manner that allows ease of removal.

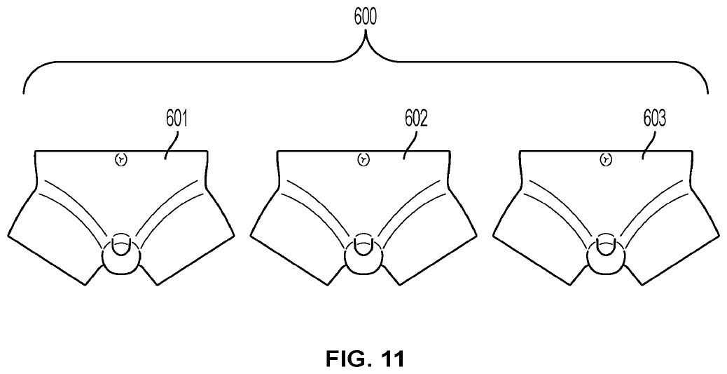

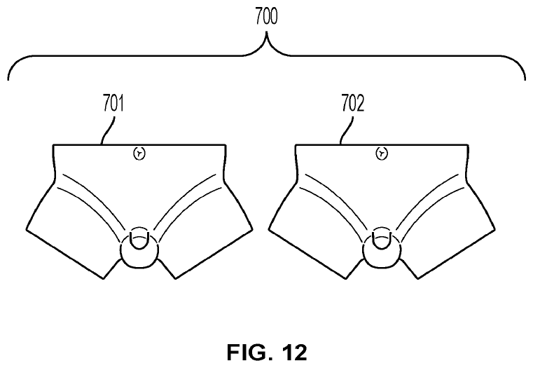

FIG. 11 shows a training kit 600 according to some embodiments. The training kit 600 may include one or more manikins 601, 602, 603, each of which may represent at least one testis condition, such as those described above with reference to FIGS. 6-9. For example, in one embodiment, manikin 601 may be similar to manikin 200 of FIG. 6, manikin 602 may be similar to manikin 300 of FIG. 7, and manikin 603 may be similar to manikin 400 of FIGS. 8A-8B. This combination is exemplary and other combinations are contemplated.

FIG. 12 shows another embodiment of a training kit 700. The training kit 700 may include two manikins 701 and 702, which together represent the various conditions discussed herein. For example, in one embodiment, manikin 701 may include (1) a normal scrotal testis on one side and (2) a palpable inguinal undescended testis on the other side and manikin 702 may include (3) a nonpalpable undescended testis on one side and (4) a palpable retractile testis on the other side. Of course it should be appreciated that manikin 701 may include (1) a normal scrotal testis on one side and (3) a nonpalpable undescended testis on the other side and manikin 702 may include (2) a palpable inguinal undescended testis on one side and (4) a palpable retractile testis on the other side. Alternatively, manikin 701 may include (1) a normal scrotal testis on one side and (4) a palpable retractile testis on the other side and manikin 702 may include (3) a nonpalpable undescended testis on one side and (2) a palpable inguinal undescended testis on the other side,

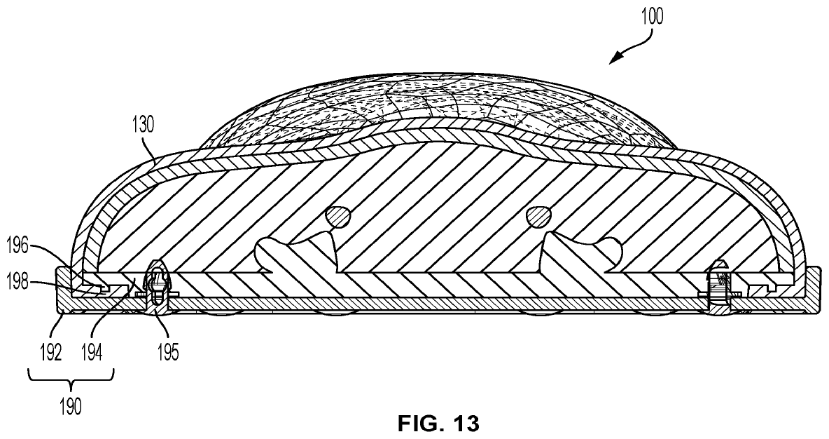

FIG. 13 shows an alternative cross-sectional view of the manikin 100. The manikin includes a two-part base structure 190 having a bottom base 192 and a top base 194. The bottom base and the top base may be snap fit together using suitable snap fasteners 195 with an edge of the outer skin layer 130 being held or pinched between the bottom and top bases. In the embodiment shown, the skin layer is wrapped around the edge of the top base and then the top base is inserted into the bottom base, or said another way, the bottom base is snapped over the top base, with the outer skin layer pinched or sandwiched between the top and bottom bases. In one embodiment, the top layer may include a protrusion 196 at its edge to mate with a corresponding recess 198 in the skin layer for added securement. The recess in the skin layer may not be preformed and instead may be a result of the clamping action of the protrusion onto the skin layer. The bottom and top bases may be capable of being disconnected from each other to free the outer skin layer. In this way, the outer skin year may be removed and replaced should the outer skin layer become worn or otherwise lose its desired properties. It should be appreciated that although snap fasteners are described, other suitable fasteners may be employed such as screws, as the present disclosure is not limited in this regard.

It should be appreciated that any suitable number of manikins may be employed in a training kit. For example, a training kit may include three manikins, each of which mimic a normal testis condition on one side (e.g., right or left) and a cryptorchidism condition (e.g., the right side of the manikins shown in FIGS. 6, 7, or 9) or a retractile testis condition (e.g., the right side of the manikin in FIGS. 8A-8B) on the opposing side. In this way, the trainee may be able to directly compare a normal and abnormal condition on one manikin. Training kits having less than and greater than three manikins are contemplated.

Any of the manikins of the kit may include a normal or abnormal condition on either side. In some embodiments, a manikin may exhibit one cryptorchidism condition on one side and another cryptorchidism condition on the other. In other embodiments, a manikin may exhibit the same cryptorchidism condition on both sides to evaluate the thoroughness of the trainee's examination. For example, the manikin may mimic bilateral cryptorchidism. In other embodiments still, a manikin may include a retractile testis on one side and a cryptorchidism testis condition on an opposing side.

In some embodiments, the training kit may include instructions for use to guide the trainee through the various potential conditions which may be examined. As described earlier, the manikins may not be visually discernible, so the trainee may be assessed on their palpation skills. The instructions may be provided in any form recognizable by one of ordinary skill in the art as a suitable vehicle for containing such instructions. For example, the instructions may be written or published, verbal, audible (e.g., telephonic), digital, optical, visual (e.g., DVD) or electronic communications (including Internet or web-based communications). In some embodiments, the instructions are provided as part of a software-based application. In certain cases, the application can be downloaded to a smartphone or device, and then guides a trainee through steps of an examination.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter ..

What is claimed is:

1. A training manikin comprising:
a body corresponding to a partial human torso, the body comprising: at least one skin layer;
at least one support layer; and
at least one canal configured to house a testis simulator,
the at least one canal disposed between the at least one skin layer and the at least one support layer in a region of the body corresponding to at least a portion of an inguinal canal.

2. The training manikin of claim 1, further comprising a fluid disposed within the at least one canal.

3. The training manikin of claim 2, further comprising the testis simulator disposed in the at least one canal, wherein the testis simulator is moveable relative to the body.

4. The training manikin of claim 1, wherein the at least one skin layer comprises an outer skin layer and an inner skin layer, and wherein the outer skin layer is formed of a stiffer material than the inner skin layer.

5. The training manikin of claim 1, wherein the at least one support layer comprises a first layer and a second layer, wherein the second layer is formed of a stiffer material than the at least one skin layer.

6. The training manikin of claim 1, wherein the manikin is configured to model one or more of the following testis conditions:
a) palpable inguinal undescended testis condition,
b) nonpalpable undescended testis condition, and/or
c) palpable retractile testis condition.

7. The training manikin of claim 1, wherein the at least one canal corresponds to at least a portion of the inguinal canal.

8. A training manikin comprising:
a body corresponding to a partial human torso, the body configured to model a nonpalpable undescended testis condition, the body comprising at least one canal disposed in a region of the body corresponding to at least a portion of an inguinal canal.

9. The training manikin of claim 8, further comprising a fluid disposed within the at least one canal.

10. The training manikin of claim 8, wherein the body further comprises:
at least one skin layer;
at least one support layer; and
wherein the at least one canal is disposed between the at least one skin layer and the at least one support layer.

11. The training manikin of claim 10, wherein the at least one skin layer comprises an outer skin layer and an inner skin layer, and wherein the outer skin layer is formed of a stiffer material than the inner skin layer.

12. The training manikin of claim 8, wherein the at least one canal corresponds to at least a portion of the inguinal canal.

13. A training manikin comprising:
a body corresponding to a partial human torso, the body comprising:
at least one testis simulator, wherein the testis simulator is moveable relative to the body.

14. The training manikin of claim 13, further comprising at least one canal corresponding to at least a portion of an inguinal canal, the at least one canal configured to house the testis simulator.

15. The training manikin of claim 14, further comprising a fluid disposed within the at least one canal.

16. The training manikin of claim 13, wherein the manikin is configured to model one or more of the following testis conditions:
a) palpable inguinal undescended testis condition,
b) nonpalpable undescended testis condition, and/or
c) palpable retractile testis condition.

17. A training kit comprising:
at least one training manikin configured to model two or more of the following testis conditions:
a) palpable inguinal undescended testis condition,
b) palpable retractile testis condition, and/or
c) normal scrotal testis.

18. A training manikin comprising:
a body corresponding to a partial human torso, the body configured to model a palpable inguinal undescended testis condition.

19. A training manikin comprising:
a body corresponding to a partial human torso, the body configured to model a palpable retractile testis condition.

20. The training manikin or kit of any of claims 17-19, further comprising at least one testis simulator moveable relative to the body.

21. The training manikin or kit of any of claims 17-19,
a body corresponding to a partial human torso, the body comprising:
at least one skin layer;
at least one support layer; and
at least one canal configured to house a testis simulator, the at least one canal disposed between the at least one skin layer and the at least one support layer.

22. The training manikin or kit of claim 21, further comprising a fluid disposed within the at least one canal.

23. The training manikin or kit of claim 21, wherein the at least one skin layer comprises an outer skin layer and an inner skin layer, and wherein the outer skin layer is formed of a stiffer material than the inner skin layer.
